(19) United States
(12) Patent Application Publication
(10) Pub. No.: US 2011/0317328 A1
(43) Pub. Date: Dec. 29, 2011

(54) CERAMIC ELECTRONIC COMPONENT AND METHOD FOR MANUFACTURING THE SAME

(75) Inventors: Susumu TANIGUCHI, Tokyo (JP); Satoshi Kurimoto, Tokyo (JP); Shintaro Tokumitsu, Tokyo (JP); Ryugen Yanagibashi, Tokyo (JP); Miyuki Yanagida, Tokyo (JP); Hisayuki Abe, Tokyo (JP)

(73) Assignee: TDK Corporation, Chuo-ku (JP)

(21) Appl. No.: 13/166,993

(22) Filed: Jun. 23, 2011

(30) Foreign Application Priority Data
Jun. 25, 2010 (JP) P2010-145139

(51) Int. Cl. H01G 4/12; H01C 7/10

(52) U.S. Cl. 361/321.1; 338/20

(57) ABSTRACT

An array-type ceramic electronic component C1 includes a ceramic body 1 in which internal electrodes are buried and a plurality of terminal electrodes 11 to 16 formed on the ceramic body 1. The terminal electrodes 11 to 16 have electrode layers formed by baking a conductive green sheet.

### BACKGROUND OF TUE INVENTION

1. Field of the Invention

The present invention relates a ceramic electronic component and a method for manufacturing the same.

2. Related Background Art

Recently, the demand for smaller and integrated ceramic electronic components has been growing to meet the increasing needs of downsizing and high performance of electronic devices. In such circumstances, an array-type ceramic electronic component in which a plurality of elements are incorporated into one chip has been drawing attention as a ceramic electronic component. For example, such an array-type ceramic electronic component may be a capacitor array including a plurality of capacitor elements in a chip.

The array-type ceramic electronic component usually includes three or more terminal electrodes on its sides. The terminal electrodes are usually provided by procedures as follows. Firstly, a conductive paste is prepared by adding a glass frit to mixed powder of noble metal such as silver and palladium or mixed powder of base metal such as copper and nickel. Next, the conductive paste is applied and baked on a ceramic body to serve as a base electrode, and Ni plating, Sn plating and the like are applied to the obtained base electrode by an electroplating method. In the above-described procedures, baking-type terminal electrodes are provided. For example, Patent Document 1 (Japanese Patent Laid-Open No. 9-275046) discloses a technique for forming terminal electrodes by filling a conductive paste in a recess of an elastic body, pressing the elastic body to one surface of an electronic component, and transferring the conductive paste to the electronic component.

### SUMMARY OF ME INVENTION

However, when a terminal electrode is formed by using only a conductive paste for manufacturing an array-type ceramic electronic component, it is difficult to accurately adjust the dimension or shape of the terminal electrode. Accordingly, it may be difficult to meet the dimensional standard when the electronic component is more downsized. Also, the thickness of the terminal electrode is easily varied in such an array-type ceramic electronic component, and its mounting stability is not favorable. Thus, an array-type ceramic electronic component having an excellent mounting stability even after being more downsized has been desired.

The present invention was made in view of the above-described circumstances. An object of the present invention is to provide an array-type ceramic electronic component having terminal electrodes which have excellent dimensional accuracy and of which a variation in thickness is sufficiently reduced.

According to an aspect of the invention, an array-type ceramic electronic component includes a ceramic body in which internal electrodes are buried and a plurality of terminal electrodes formed on the ceramic body. The terminal electrodes have electrode layers formed by baking a conductive green sheet.

The array-type ceramic electronic component includes the terminal electrodes having the electrode layers (hereinafter referred to as “first electrode layers”) formed by baking a conductive green sheet that is a sheet-like electrode material having a predetermined shape (thickness, length, width). Thus, as compared to a ceramic electronic component including terminal electrodes formed by using only a conductive paste, the variation in thickness of the terminal electrodes can be reduced and the dimensional accuracy can be improved.

It is preferable that the terminal electrodes of the ceramic electronic component further have electrode layers (hereinafter referred to as “second electrode layers”) formed by baking a conductive paste between the first electrode layers and the ceramic body. The second electrode layers contribute to improvement in adhesiveness between the first electrode layers and the ceramic body. The reliability of the array-type ceramic electronic component can be improved due to the terminal electrodes including the second electrode layers.

It is preferable that the first electrode layer covers the whole second electrode layer on a corner of the ceramic body of the present invention. Therefore, the corner of the ceramic body which is usually damaged easily can be protected by the first electrode layers formed by baking the conductive green sheet. Also, a plating liquid can be sufficiently prevented from entering into the ceramic body when a plating layer is formed on the first electrode layer. Thus, the reliability of the array-type ceramic electronic component can be further improved.

It is preferable that the first electrode layer covers part of the second electrode layer on at least one plane of main surfaces and side surfaces of the ceramic body of the ceramic electronic component according to the invention. Accordingly, a stress generated by a difference of degrees of shrinkage based on sinterability of the electrode layers can be suppressed as compared to when the first electrode layer covers the whole second electrode layer. Further, the first electrode layer and the second electrode layer are less separated from each other and cracks are less generated on the terminal electrodes. Thus, the reliability of the array-type ceramic electronic component can be further improved.

The ceramic electronic component according to the aspect of the invention can be manufactured by a method for manufacturing an array-type ceramic electronic component including a ceramic body in which internal electrodes are buried and a plurality of terminal electrodes formed on the ceramic body. The method includes a step of attaching a conductive green sheet onto the ceramic body and a step of baking the conductive green sheet and forming terminal electrodes on a surface of the ceramic body.

According to the method for manufacturing the array-type ceramic electronic component as described above, the variation in thickness of the terminal electrodes can be reduced and the dimensional accuracy can be improved because the terminal electrodes are formed by using the conductive green sheet having a predetermined shape (thickness, length, width).

It is preferable that the method for manufacturing the ceramic electronic component as described above has a step of adhering a conductive paste onto the ceramic body before the attaching step. Further, it is preferable that the conductive green sheet be attached onto the conductive paste in the attaching step and the terminal electrodes be formed by baking the conductive paste with the conductive green sheet in the baking step. Thus, the adhesiveness between the terminal electrodes and the ceramic body can be improved, and the reliability of the ceramic electronic component can be improved.

According to the present invention, the array-type ceramic electronic component having terminal electrodes which have excellent dimensional accuracy and in which the variation in thickness is sufficiently suppressed can be provided.

### BRIEF DESCRIPTION OF THE DRAWINGS

FIG. 1 is a perspective view of a multilayer capacitor array of a ceramic electronic component according to a preferred embodiment of the present invention.

FIG. 2 is an exploded perspective view of a capacitor body included in the multilayer capacitor array shown in FIG. 1.

FIG. 3 is a cross-sectional view of the multilayer capacitor array taken along the line III-III of FIG. 1.

FIG. 4 is a fragmentary cross-sectional view showing a cross section of a portion in the vicinity of a corner of the ceramic electronic component of the present invention in an enlarged manner.

FIG. 5 is a schematic view schematically showing a process of a method for manufacturing the ceramic electronic component according to the preferred embodiment of the present invention.

FIG. 6 is a schematic view schematically showing a process of the method for manufacturing the ceramic electronic component according to the preferred embodiment of the present invention.

FIG. 7 is a perspective view of a multilayer capacitor array of a ceramic electronic component according to another embodiment of the present invention.

FIG. 8 is an exploded perspective view of a capacitor body included in the multilayer capacitor array shown in FIG. 7.

### DESCRIPTION OF THE PREFERRED EMBODIMENTS

A preferred embodiment of the present invention will be explained below possibly with reference to the drawings. It should be noted that the same reference numerals are assigned to the same or equivalent parts and a detailed description thereof is omitted. Also, a dimensional ratio of each component or member is not limited to the ratio shown in the drawings.

The ceramic electronic component according to the embodiment is a multilayer capacitor array which is a type of array-type ceramic electronic components having three or more terminal electrodes on its side surfaces. Here, the array-type ceramic electronic component is an electronic component provided by incorporating a plurality of elements (for example, capacitors or varistors) to a ceramic body in which dielectric materials or nonlinear resistor materials (varistor materials) are laminated as ceramic materials.

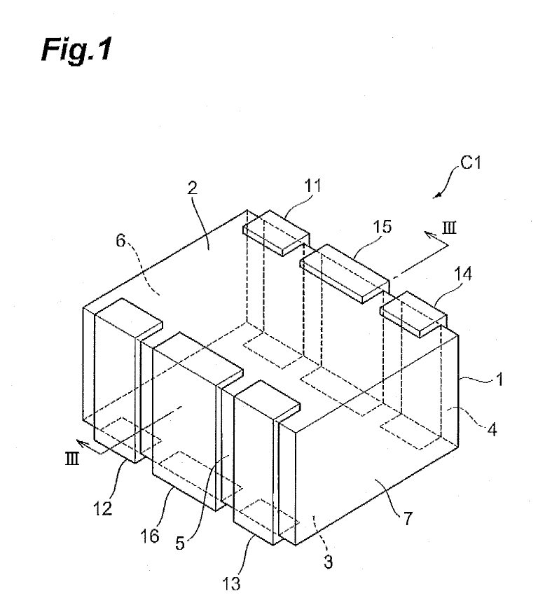

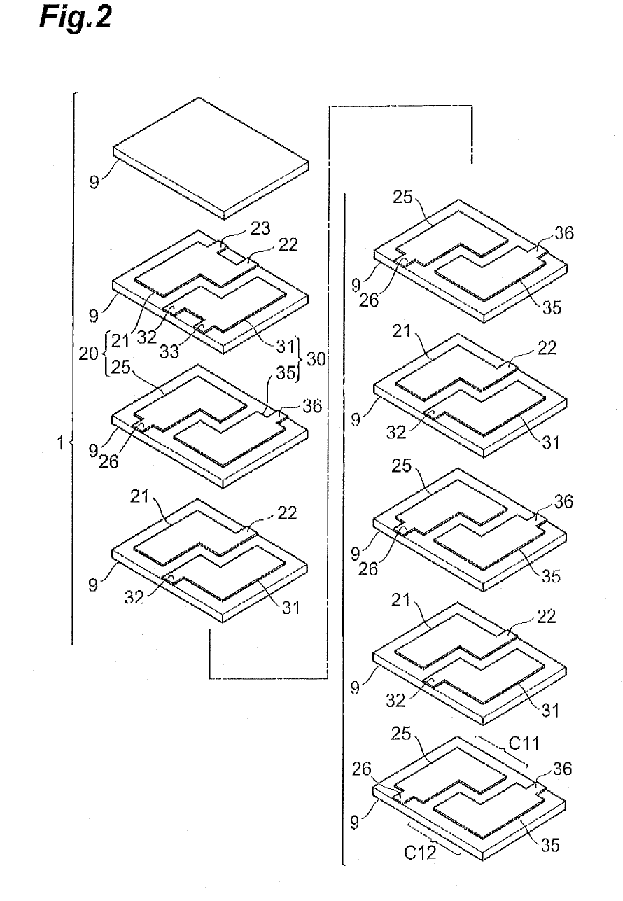

FIG. 1 is a perspective view of a multilayer capacitor array of the ceramic electronic component according to the preferred embodiment of the present invention. FIG. 2 is an exploded perspective view of a capacitor body (ceramic body) included in the multilayer capacitor array shown in FIG. 1. The multilayer capacitor array according to the embodiment will be explained with reference to FIGS. 1 and 2.

The multilayer capacitor array C1 includes a laminated body 1 serving as a capacitor body and a plurality of terminal electrodes 11 to 16 arranged on the outer surface of the laminated body 1. The laminated body 1 has a rectangular parallelepiped shape. The laminated body 1 includes first and second main surfaces 2 and 3 which are opposite to each other, first and second side surfaces 4 and 5 which are orthogonal to the first and second main surfaces 2 and 3 and opposite to each other, and third and fourth side surfaces 6 and 7 which are orthogonal to the first and second main surfaces 2 and 3 and the first and second side surfaces 4 and 5 and which are opposite to each other. The first main surface 2 or the second main surface 3 serves as a mounting surface at which the multilayer capacitor array C1 is mounted to other components (for example, a circuit board or an electronic component).

The multilayer capacitor array C1 includes first to sixth terminal electrodes 11 to 16 on the first and second side surfaces 4 and 5. The first terminal electrode 11, the fourth terminal electrode 14, and the fifth terminal electrode 15 are arranged on the first side surface 4 of the laminated body 1 to cover part of the first side surface 4 at predetermined intervals. The first terminal electrode 11, the fourth terminal electrode 14, and the fifth terminal electrode 15 extend from the first main surface 2 to the second main surface 3 so as to partly cover the first side surface 4 in the direction where the first and second main surfaces 2 and 3 are opposite to each other, respectively. The first terminal electrode 11, the fourth terminal electrode 14, and the fifth terminal electrode 15 are electrically insulated from each other on the outer surface of the laminated body 1. The first terminal electrode 11, the fifth terminal electrode 15, and the fourth terminal electrode 14 are arranged in this order on the first side surface 4 of the laminated body 1 in the direction from the third side surface 6 to the fourth side surface 7.

The second terminal electrode 12, the third terminal electrode 13, and the sixth terminal electrode 16 are arranged on the second side surface 5 of the laminated body 1 to cover part of the second side surface 5 at predetermined intervals. The second terminal electrode 12, the third terminal electrode 13, and the sixth terminal electrode 16 extend from the first main surface 2 to the second main surface 3 so as to partially cover the second side surface 5 in the direction where the first and second main surfaces 2 and 3 are opposite to each other, respectively. The second terminal electrode 12, the third terminal electrode 13, and the sixth terminal electrode 16 are electrically insulated from each other on the outer surface of the laminated body 1. The second terminal electrode 12, the sixth terminal electrode 16, and the third terminal electrode 13 are arranged in this order on the second side surface 5 of the laminated body 1 in the direction from the third side surface 6 to the fourth side surface 7.

As shown in FIG. 2, the laminated body 1 includes a plurality of dielectric layers (ceramic layers) 9. The laminated body 1 is formed by laminating and integrating the plurality of dielectric layers 9 in the direction where the first and second main surfaces 2 and 3 are opposite to each other. The dielectric layers 9 are composed of, for example, a sintered body of a ceramic green sheet containing a dielectric ceramic material (a dielectric ceramic such as BaTiO₃, Ba(Ti, Zr)O₃, or (Ba, Ca)TiO₃).

A first internal electrode group 20 and a second internal electrode group 30 are buried between the plurality of dielectric layers 9 in the laminated body 1. The first internal electrode group 20 includes a plurality of first internal electrodes 21 and a plurality of second internal electrodes 25. The second internal electrode group 30 includes a plurality of third internal electrodes 31 and a plurality of fourth internal electrodes 35. The first to fourth internal electrodes 21, 25, 31, and 35 are arranged in the laminated body 1. The first to fourth internal electrodes 21, 25, 31, and 35 are made of a conductive material normally used as an internal electrode of a laminated electrical element (for example, base metal Ni).

The laminated body 1 includes an area where the first internal electrode group 20 is disposed and an area where the second internal electrode group 30 is disposed. These areas are arranged in the direction where the third and fourth side surfaces 6 and 7 are opposite to each other. In other words, in the laminated body 1, the first internal electrode group 20 and the second internal electrode group 30 are laid in parallel in the direction where the third and fourth side surfaces 6 and 7 are opposite to each other. Specifically, the first internal electrode group 20 is provided on the side close to the third side surface 6, and the second internal electrode group 30 is provided on the side close to the fourth side surface 7.

The plurality of first and second internal electrodes 21 and 25 are opposite to each other to interpose one dielectric layer 9 therebetween. The plurality of third and fourth internal electrodes 31 and 35 are opposite to each other to interpose one dielectric layer 9 therebetween.

The first internal electrodes 21 and the third internal electrodes 31 are provided at predetermined intervals in the direction where the third and fourth side surfaces 6 and 7 are opposite to each other, and are arranged at the same position (i.e., on the same layer) in the direction where the first and second main surfaces 2 and 3 are opposite to each other. The first and third internal electrodes 21 and 31 are arranged in this order in the direction from the third side surface 6 to the fourth side surface 7.

The second internal electrodes 25 and the fourth internal electrodes 35 are provided at predetermined intervals in the direction where the third and fourth side surfaces 6 and 7 are opposite to each other, and are arranged on the same position (i.e., on the same layer) in the direction where the first and second main surfaces 2 and 3 are opposite to each other. The second and fourth internal electrodes 25 and 35 are arranged in this order in the direction from the third side surface 6 to the fourth side surface 7.

Each first internal electrode 21 has a lead-out conductor 22 extending to the first side surface 4 of the laminated body 1. The lead-out conductor 22 has one end connected to the edge of the first internal electrode 21 close to the first side surface 4 and has the other end exposed to the first side surface 4. The lead-out conductor 22 is integrated with the first internal electrode 21.

The fifth terminal electrode 15 covers all portions of the lead-out conductors 22 which are exposed to the first side surface 4. The lead-out conductors 22 are connected to the fifth terminal electrode 15. Accordingly, the first internal electrodes 21 are electrically connected to each other through the fifth terminal electrode 15. Thus, the first internal electrodes 21 are connected in parallel.

Out of the first internal electrodes 21, the first internal electrode 21 disposed closest to the main surface 2 has a lead-out conductor 23 extending to the first side surface 4 of the laminated body 1 in addition to the lead-out conductor 22. The lead-out conductor 23 has one end connected to the edge of the first internal electrode 21 close to the first side surface 4 and has the other end exposed to the first side surface 4. The lead-out conductor 23 is integrated with the first internal electrode 21.

The first terminal electrode 11 covers all portions of the lead-out conductors 23 which are exposed to the first side surface 4. The lead-out conductors 23 are connected to the first terminal electrode 11. Since the first internal electrodes 21 are electrically connected to each other through the fifth terminal electrodes 15, all of the first internal electrodes 21 are electrically connected to the first terminal electrode 11.

Each second internal electrode 25 has a lead-out conductor 26 extending to the second side surface 5 of the laminated body 1. The lead-out conductor 26 has one end connected to the edge of the second internal electrode 25 close to the second side surface 5 and has the other end exposed to the second side surface 5. The lead-out conductor 26 is integrated with the second internal electrode 25.

The second terminal electrode 12 covers all portions of the lead-out conductors 26 which are exposed to the second side surface 5. The lead-out conductors 26 are connected to the second terminal electrode 12. Accordingly, all of the second internal electrodes 25 are electrically connected to each other through the second terminal electrode 12.

Each third internal electrode 31 has a lead-out conductor 32 extending to the second side surface 5 of the laminated body 1. The lead-out conductor 32 has one end connected to the edge of the third internal electrode 31 close to the second side surface 5 and has the other end exposed to the second side surface 5. The lead-out conductor 32 is integrated with the third internal electrode 31.

The sixth terminal electrode 16 covers all portions of the lead-out conductors 32 which are exposed to the second side surface 5. The lead-out conductors 32 are connected to the sixth terminal electrode 16. Accordingly, all of the third internal electrodes 31 are electrically connected to each other through the sixth terminal electrode 16. Thus, the third internal electrodes 31 are connected in parallel.

Out of the third internal electrodes 31, the third internal electrode 31 disposed closest to the main surface 2 has a lead-out conductor 33 extending to the second side surface 5 of the laminated body 1. The lead-out conductor 33 has one end connected to the edge of the third internal electrode 31 close to the second side surface 5 and has the other end exposed to the second side surface 5. The lead-out conductor 33 is integrated with the third internal electrode 31.

The third terminal electrode 13 covers all portions of the lead-out conductors 33 which are exposed to the second side surface 5. The lead-out conductors 33 are connected to the third terminal electrode 13. Since the third internal electrodes 31 are electrically connected to each other through the sixth terminal electrode 16, all of the third internal electrodes 31 are electrically connected to the third terminal electrode 13.

Each fourth internal electrode 35 has a lead-out conductor 36 extending to the first side surface 4 of the laminated body 1. The lead-out conductor 36 has one end connected to the edge of the fourth internal electrode 35 close to the first side surface 4 and has the other end exposed to the first side surface 4. The lead-out conductor 36 is integrated with the fourth internal electrode 35.

The fourth terminal electrode 14 covers all portions of the lead-out conductors 36 which are exposed to the first side surface 4. The lead-out conductors 36 are connected to the fourth terminal electrode 14. Accordingly, all of the fourth internal electrodes 35 are electrically connected to each other through the fourth terminal electrodes 14.

As described above, in the multilayer capacitor array C1, a first capacitor C11 is formed by the plurality of first and second internal electrodes 21 and 25 and the plurality of dielectric layers 9. More specifically, the first capacitor C11 is formed by the plurality of first and second internal electrodes 21 and 25 and the dielectric layers 9 each interposed between the first and second internal electrodes 21 and 25. In the multilayer capacitor array C1, a second capacitor C12 is formed by the plurality of third and fourth internal electrodes 31 and 35 and the plurality of dielectric layers 9. More specifically, the second capacitor C12 is formed by the plurality of third and fourth internal electrodes 31 and 35 and the dielectric layers 9 each interposed between the third and fourth internal electrodes 31 and 35.

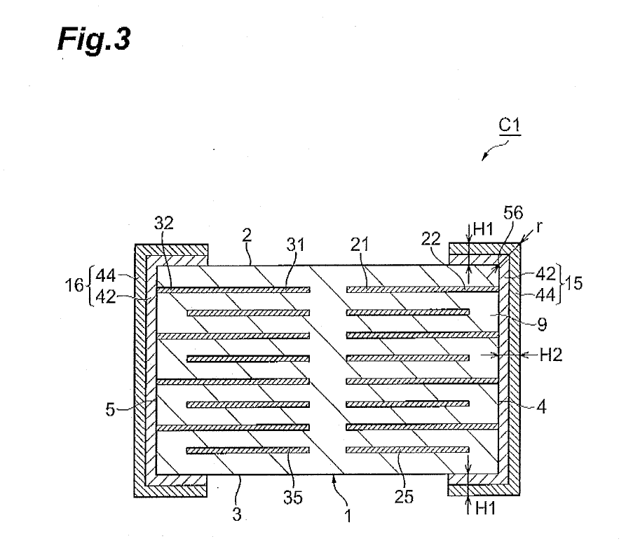

FIG. 3 is a cross-sectional view of the multilayer capacitor array C1 taken along the line III-III of FIG. 1. The fifth and sixth terminal electrodes 15 and 16 are provided on the first and second side surfaces 4 and 5 of the multilayer capacitor array C1, respectively, and have a laminated structure in which a second electrode layer 42 and a first electrode layer 44 are sequentially laminated from the surface (the first and second side surfaces 4 and 5) of the laminated body 1. Specifically, the second electrode layer 42 is in contact with the first and second side surfaces 4 and 5 and the first and second main surfaces 2 and 3 of the laminated body 1, and the first electrode layer 44 covers the second electrode layer 42.

The second electrode layer 42 is formed by baking a conductive paste containing a conductive metal powder, a glass fit, and at least one of a binder, a dispersant and a solvent, for example. For example, the second electrode layer 42 contains a glass component and a metal component comprising at least one element selected from Cu, Ag, Pd, Au, Pt, Fe, Zn, Al, Sn, and Ni. The second electrode layer 42 is disposed between the laminated body 1 and the first electrode layer 44 and is tightly attached to the laminated body 1 and the first electrode layer 44. Thus, the fifth and sixth terminal electrodes 15 and 16 can be attached to the laminated body 1 more tightly, and the reliability of the multilayer capacitor array C1 can be sufficiently improved.

The first electrode layer 44 is formed by baking a conductive green sheet containing a conductive metal powder, a glass frit, and at least one of a binder, a dispersant and a solvent, for example. Accordingly, the first electrode layer 44 has high dimensional accuracy. The size and shape of the fifth and sixth terminal electrodes 15 and 16 can be adjusted highly accurately, so that the fifth and sixth terminal electrodes 15 and 16 can be disposed with high positional accuracy. Also, the variation in thickness of the fifth and sixth terminal electrodes 15 and 16 can be sufficiently reduced. The first electrode layer 44 contains a metal component comprising at least one element selected from Cu, Ag, Pd, Au, Pt, Fe, Zn, Al, Sn, and Ni, for example. The glass component content of the first electrode layer 44 may be less than that of the second electrode layer 42. The first electrode layer 44 may not contain the glass component.

Similarly to the fifth and sixth terminal electrodes 15 and 16, the first to fourth terminal electrodes 11 to 14 provided on the first and second side surfaces 4 and 5, respectively, and have a laminated structure in which the second electrode layer 42 and the first electrode layer 44 are sequentially laminated as shown in FIG. 3. Thus, the multilayer capacitor array C1 according to this embodiment can be disposed with high positional accuracy by adjusting the size and shape of the first to sixth terminal electrodes 11 to 16 highly accurately. In addition, the variation in thickness of the first to sixth terminal electrodes 11 to 16 can be sufficiently reduced.

Since each of the first to sixth terminal electrodes 11 to 16 has the first electrode layer 44 formed using the conductive green sheet, the difference among a thickness r of the terminal electrode at a corner 56 of the laminated body 1, a thickness H1 of the terminal electrode provided on the main surfaces 2 and 3, and a thickness H2 of the terminal electrode provided on the side surfaces 4 and 5 is sufficiently reduced as compared to a terminal electrode formed by using only a conductive paste. Especially, since the thickness r can be increased without increasing the thicknesses H1 and H2, the reliability of the multilayer capacitor array can be improved. Also, the variation in each of the thicknesses H1, H2, and r can be reduced.

The first to sixth terminal electrodes 11 to 16 may have a plating layer on the surface of the first electrode layer 44. At this time, the second electrode layer 42 and the first electrode layer 44 are baked from the side close to the laminated body 1 and then the plating layer is formed thereon. Thus, the first to sixth terminal electrodes 11 to 16 have a laminated structure in which the second electrode layer 42, the first electrode layer 44, and the plating layer are sequentially laminated. Incidentally, the plating layer may have a laminated structure in which a lei plating layer and a Sn plating layer are sequentially laminated from the side close to the first electrode layer 44.

The first electrode layer 44 of each of the first to sixth terminal electrodes 11 to 16 may cover part of the second electrode layer 42 on at least one surface selected from the first and second main surfaces 2 and 3 and the first and second side surfaces 4 and 5 of the laminated body 1. At this time, the other part of the second electrode layer 42 is not covered by the first electrode layer 44 and is directly contacted with the plating layer. With such a structure, a stress generated by a difference of degrees of shrinkage based on sinterability of the first electrode layer 44 and the second electrode layer 42 can be reduced. Consequently, it can be restrained that the first electrode layer 44 and the second electrode layer 42 are detached. In addition, it can be restrained that cracks occur to the first to sixth terminal electrodes 11 to 16.

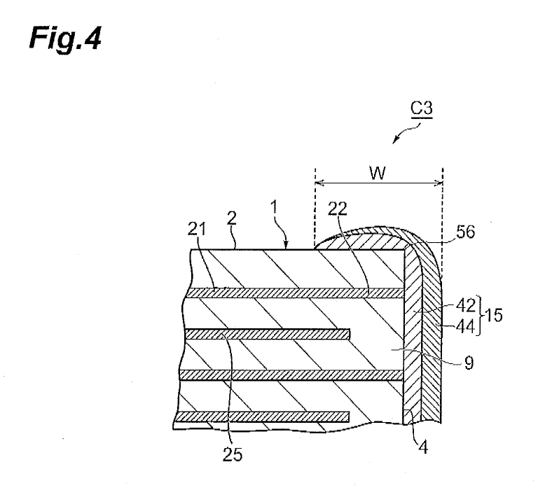

FIG. 4 is a fragmentary cross-sectional view showing part of a cross section of a modification of the ceramic electronic component C1 in an enlarged manner. In other words, FIG. 4 is a fragmentary cross-sectional view showing a corner of the ceramic electronic component in cross section similar to FIG. 3. The fifth terminal electrode 15 of the ceramic electronic component C3 extends from the first side surface 4 to the first main surface 2. The first electrode layer 44 covers the entire second electrode layer 42 at the corner 56 of the ceramic body 1. The thickness of an end portion of the first electrode layer 44 on the first main surface 2 is gradually reduced toward a central portion of the first main surface 2, and an end of the end portion is integrated with the second electrode layer 42. Thus, the variation in thickness of the fifth terminal electrode 15 on the first main surface 2 can be reduced.

Similarly to the fifth terminal electrode 15, the first to fourth terminal electrodes 11 to 14 and the sixth terminal electrode 16 provided on the first and second side surfaces 4 and 5 have a laminated structure in which the second electrode layer 42 and the first electrode layer 44 are sequentially laminated as shown in FIG. 4. The first electrode layer 44 is formed using a conductive green sheet. Accordingly, the variation in length of roundabout portions W of the first to sixth terminal electrodes 11 to 16 can be reduced.

Next, a method for manufacturing the ceramic electronic component according to the preferred embodiment of the present invention will be explained below. The method for manufacturing the ceramic electronic component according to this embodiment is a method for manufacturing the multilayer capacitor array C1 as shown in FIGS. 1 and 2. The method for manufacturing the multilayer capacitor array C1 includes a step of forming the laminated body 1, a step of forming a conductive green sheet, a step of adhering a conductive paste, a step of attaching the conductive green sheet, a drying step, an electrode baking step, and a plating step. Each step will be explained below in detail with reference to the drawings accordingly.

In the step of forming the laminated body 1, a ceramic green sheet is initially prepared to form the dielectric layer 9. The ceramic green sheet is prepared by applying a ceramic slurry onto a PET (polyethylene terephthalate) film using a doctor blade method or the like and drying it. For example, the ceramic slurry may be obtained by adding such as a solvent and a plasticizer to a dielectric material mainly containing barium titanate and mixing together. Electrode patterns of internal electrodes and lead-out electrodes are screen-printed on the prepared ceramic green sheet. Then, the ceramic green sheet is dried. For screen printing of the electrode patterns, an electrode paste prepared by mixing such as a binder and a solvent to a Cu powder or a Ni powder may be used.

Usually, a plurality of electrode patterns are arranged in a matrix in a plane of the ceramic green sheet to simultaneously form a plurality of capacitor bodies. A plurality of green sheets with electrode patterns are prepared and laminated. Then, the laminated green sheets are cut in two planes parallel and orthogonal to the laminated direction for every array, so that rectangular parallelepiped shape multilayer chip, i.e., a capacitor green body, is formed. Subsequently, the multilayer chip is heated to remove a binder. The heating process is preferably conducted at 180 to 400° C. for 0.5 to 30 hours. The multilayer chip obtained by the heating process is burned at 800 to 1400° C. for 0.5 to 8.0 hours, and are chamfered by barrel finishing as necessary. Thus, the laminated body 1 having a rectangular parallelepiped shape can be obtained.

In the step of forming the conductive green sheet, a paste for the conductive green sheet is initially applied onto a PET (polyethylene terephthalate) film to have approximately 70 μm thickness. As the paste for the conductive green sheet, a paste prepared by mixing a metal or alloy powder containing Cu, Ag, Pd, Au, Pt, Fe, Zn, Al, Sn, or Ni, a resin binder, and an organic solvent may be used.

Next, the paste applied onto the PET film is dried to form the conductive green sheet. In the dried conductive green sheet, the organic component may be remained as long as a good shape retention property is obtained. The thickness of the conductive green sheet is approximately 10 to 50 μm.

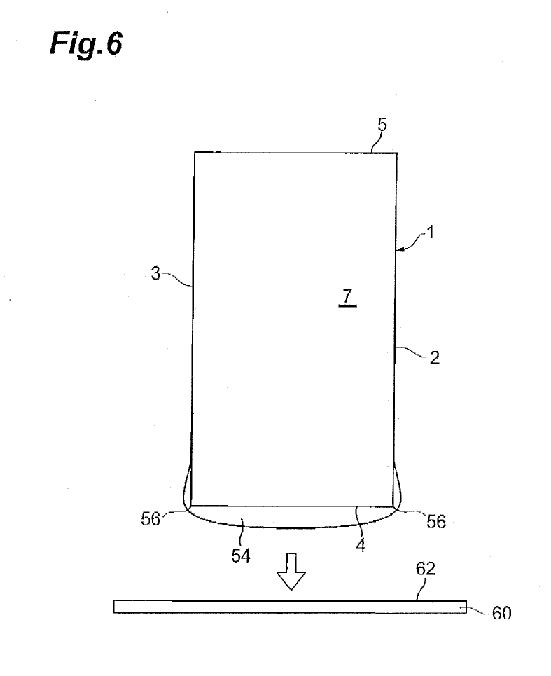

The conductive green sheet is cut to have a desired size (length, width) on the PET film and is peeled from the PET film to form a conductive green sheet 60 (FIG. 6). At this time, it is preferable that the conductive green sheet be cut such that a conductive green sheet surface 62 attached to the laminated body 1 has the same size as the surface of the conductive paste applied to the first side surface 4 or the second side surface 5 of the laminated body 1. It is also preferable that the conductive green sheet be cut such that the conductive green sheet surface 62 attached to the laminated body 1 has the size enough to cover all of the lead-out conductors exposed to the first side surface 4 or the second side surface 5 of the laminated body 1. Accordingly, each terminal electrode has a shape along a profile of the laminated body 1, and thus the multilayer capacitor array C1 having the terminal electrodes with high dimensional accuracy can be provided.

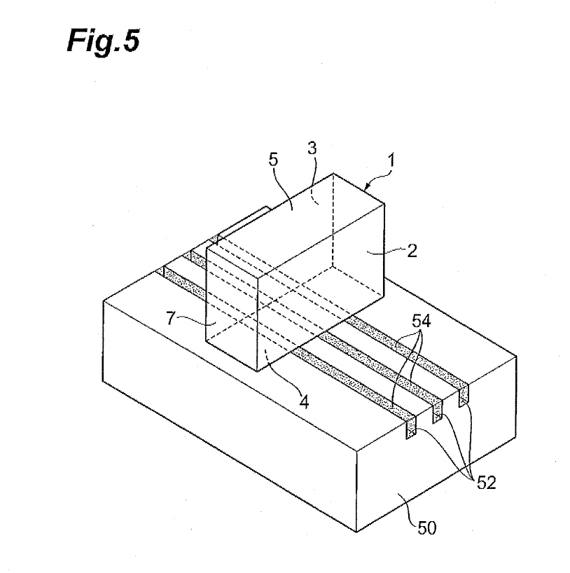

In the step of adhering the conductive paste, the conductive paste is adhered to the surface of the laminated body 1 corresponding to the positions of the terminal electrodes of the multilayer capacitor array C1. The conductive paste may be prepared by adding a glass fit to the component contained in the paste for the conductive green sheet. The conductive paste may be adhered to the laminated body 1 by a method as shown in FIG. 5.

FIG. 5 is a schematic view schematically showing the step of adhering the conductive paste in the method for manufacturing the multilayer capacitor array C1 according to this embodiment. Firstly, an elastic body 50 such as a rubber on which three grooves 52 are formed corresponding to the width and interval of the lead-out conductors on one surface is prepared. After the grooves 52 are filled with the conductive paste 54 using a dispenser or the like, the surface of the conductive paste 54 is smoothed, for example, by being scraped by a squeegee. At this time, the conductive paste 54 overflowed from the grooves 52 of the elastic body 50 may be scraped.

Then, the laminated body 1 is positioned on the elastic body 50 such that the second electrode layer 42 is formed at a predetermined position of the first side surface 4 of the laminated body 1, i.e., at a position where the lead-out conductors are exposed. After positioning the laminated body 1, the elastic body 50 is pressed to the first side surface 4 of the laminated body 1 by moving the elastic body 50 toward the laminated body 1 as shown in FIG. 5. The laminated body 1 is buried in the elastic body 50, and the conductive paste 54 filled in the grooves 52 is transferred to the first side surface 4 and further to part of the first and second main surfaces 2 and 3 adjacent to the first side surface 4 of the laminated body 1. Thus, the conductive paste 54 is continuously adhered to three portions on the laminated body 1 by covering part of the first side surface 4 from the first main surface 2 to the second main surface 3 in the direction where the first and second main surfaces 2 and 3 are opposite to each other. In other words, the three second electrode layers 42 are formed.

FIG. 6 is a schematic view for explaining the step of attaching the conductive green sheet in the method for manufacturing the multilayer capacitor array C1 according to this embodiment. FIG. 6 schematically illustrates the attaching step as viewed in the direction orthogonal to the fourth side surface 7 of the laminated body 1. In the step of attaching the conductive green sheet, the surface 62 of the conductive green sheet 60 is attached to the conductive paste 54 adhered to the first side surface 4 of the laminated body 1 as shown in FIG. 6. In other words, the laminated body 1 is pressed to the conductive green sheet 60 on the PET film such that the first side surface 4 of the laminated body 1 to which the conductive paste 54 is adhered faces the surface 62 of the conductive green sheet 60. Subsequently, the conductive green sheet 60 is peeled from the PET film. Thus, the conductive green sheet 60 is attached to the conductive paste 54.

When the conductive green sheet 60 is attached to the conductive paste 54 adhered to the first side surface 4 of the laminated body 1, the conductive green sheet 60 is deformed along the corners 56 of the laminated body 1 by the conductive paste 54 applied to the first and second main surfaces 2 and 3 of the laminated body 1. In other words, the conductive green sheet 60 is deformed to cover the conductive paste applied to the first side surface 4, the corners 56, and the first and second main surfaces 2 and 3. The conductive green sheet 60 is deformed as such because the organic solvent contained in the conductive paste 54 is swept into the almost dried conductive green sheet 60 and the organic component remained in the conductive green sheet 60 is solved. In this mariner, the conductive green sheet 60 is attached to the laminated body 1 through the conductive paste 54, and the conductive green sheet 60 and the conductive paste 54 are integrated. Incidentally, the organic component remained in the conductive green sheet 60 may be the binder contained in the paste for the conductive green sheet, for example.

The multilayer capacitor array C1 has the three terminal electrodes 11, 14, and 15 on the side surface 4. Accordingly, the three conductive green sheets 60 are prepared in the attaching step. Then, the conductive green sheets 60 are disposed at the positions corresponding to the conductive paste applied to the three portions of the laminated body 1. Then, the laminated body 1 is pressed toward the three conductive green sheets 60. Thus, the three conductive green sheets 60 are attached to the conductive paste applied to three portions of the side surface 4.

In the drying step, the conductive paste 54 and the conductive green sheets 60 attached to the laminated body 1 are dried to form precursor layers of the terminal electrodes 11, 14, and 15 in which a first conductive layer and a second conductive layer are laminated from the surface (the first side surface 4) of the laminated body 1. Incidentally, by adjusting the content of the conductive paste 54 and the conductive green sheets 60, the compositions of the first conductive layer and the second conductive layer may be different from each other. For example, the integration property or adhesiveness of the conductive paste 54 and the conductive green sheets 60 can be adjusted by adjusting the content of the binder contained in the conductive paste 54.

Subsequently, the step of adhering the conductive paste, the step of attaching the conductive green sheet, and the step of drying the conductive green sheet are conducted on the second side surface 5 of the laminated body 1, similarly to the first side surface 4. Thus, the precursor layers of the terminal electrodes 12, 13, and 16 are formed on the second side surface 5 of the laminated body 1.

In the electrode baking step, a terminal electrode in which the second electrode layer 42 and the first electrode layer 44 are sequentially laminated from the side close to the laminated body 1 is formed by baking the precursor layers of the terminal electrodes 11, 14, and 15 formed on the first side surface 4 and the precursor layers of the terminal electrodes 12, 13, and 16 formed on the second side surface 5. This baking process is conducted, for example, at 400 to 850° C. for 0.2 to 5.0 hours in the air or reductive atmosphere.

After the electrode baking step, the plating step of providing a plating layer on the first electrode layer 44 on each terminal electrode may be conducted. In the plating step, the plating layer is formed on each first electrode layer 44 by electrically plating each terminal electrode. The plating layer may be formed by a barrel plating using, for example, Ni plating bath (for example, watts bath) and Sn plating bath (for example, neutral Sn plating bath). Thus, the plating layer in which the Ni plating layer and the Sn plating layer are sequentially formed from the side close to the first electrode layer 44 can be obtained.

In the multilayer capacitor array C1 obtained by the above-described steps, the terminal electrodes 11 to 16 include the first electrode layers 44 formed by baking the conductive green sheets 60 on the second electrode layers 42 derived from the conductive paste 54. Therefore, the shape (the width and the length of the roundabout portion W) and the thicknesses (H1, H2, r) of each terminal electrode can be adjusted with high accuracy as compared with terminal electrodes formed using only a conductive paste. Also, the uniformity of the thicknesses (H1, H2, r) of the terminal electrode can be improved as compared with the terminal electrodes formed using only the conductive paste. Consequently, the thickness (r) of each terminal electrode at the corner of the multilayer capacitor array C1 in particular is not thinned (the relationship: H1, H2>r is avoided), and thus the multilayer capacitor array C1 has excellent reliability.

Additionally, the multilayer capacitor array C1 includes the second electrode layer 42 by interposing the conductive paste 54 between the first electrode layer 44 and the laminated body 1. Thus, the adhesiveness between the laminated body 1 and the terminal electrodes 11 to 16 is improved.

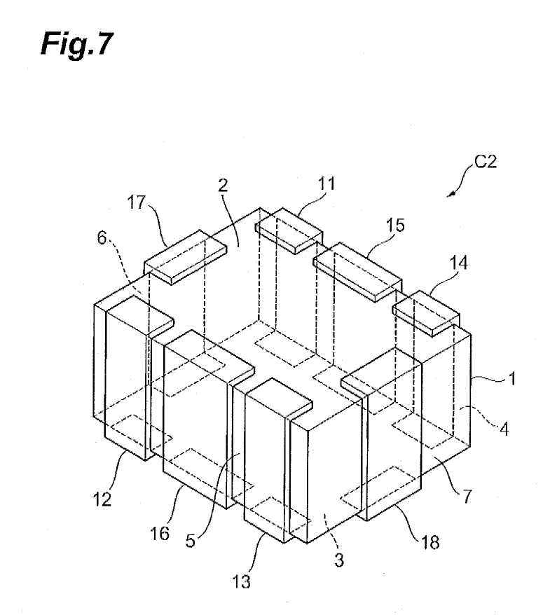

FIG. 7 is a perspective view of a multilayer capacitor array of a ceramic electronic component according to another preferred embodiment of the present invention. A multilayer capacitor array C2 according to the other embodiment of the present invention will be explained with reference to the drawings.

The multilayer capacitor array C2 is different from the multilayer capacitor array C1 according to the above-described embodiment in terms of the number of terminal electrodes and the like. As shown in FIG. 7, the multilayer capacitor array C2 includes the laminated body 1 serving as a capacitor body and a plurality of terminal electrodes 11 to 18 disposed on the outer surface of the laminated body 1.

Similarly to the first to sixth terminal electrodes 11 to 16, the seventh and eighth terminal electrodes 17 and 18 have a laminated structure in which the second electrode layer 42 derived from the conductive paste and the first electrode layer 44 derived from the conductive green sheet are laminated from the surfaces (the first and second side surfaces 4 and 5) of the laminated body 1. The seventh and eighth terminal electrodes 17 and 18 may have a plating layer on the first electrode layer 44 as necessary, similarly to the first to sixth terminal electrodes 11 to 16.

The seventh terminal electrode 17 is arranged on the third side surface 6 of the laminated body 1. The seventh terminal electrode 17 extends from the first main surface 2 to the second main surface 3 so as to partially cover the third side surface 6 in the direction where the first and second main surfaces 2 and 3 are opposite to each other. The seventh terminal electrode 17 is disposed at an approximately central portion of the third side surface 6 in the direction where the first and second side surfaces 4 and 5 are opposite to each other.

The eighth terminal electrode 18 is disposed on the fourth side surface 7 of the laminated body 1. The eighth terminal electrode 18 extends from the first main surface 2 to the second main surface 3 so as to partially cover the fourth side surface 7 in the direction where the first and second main surfaces 2 and 3 are opposite to each other. The eighth terminal electrode 18 is disposed at an approximately central portion of the fourth side surface 7 in the direction where the first and second side surfaces 4 and 5 are opposite to each other.

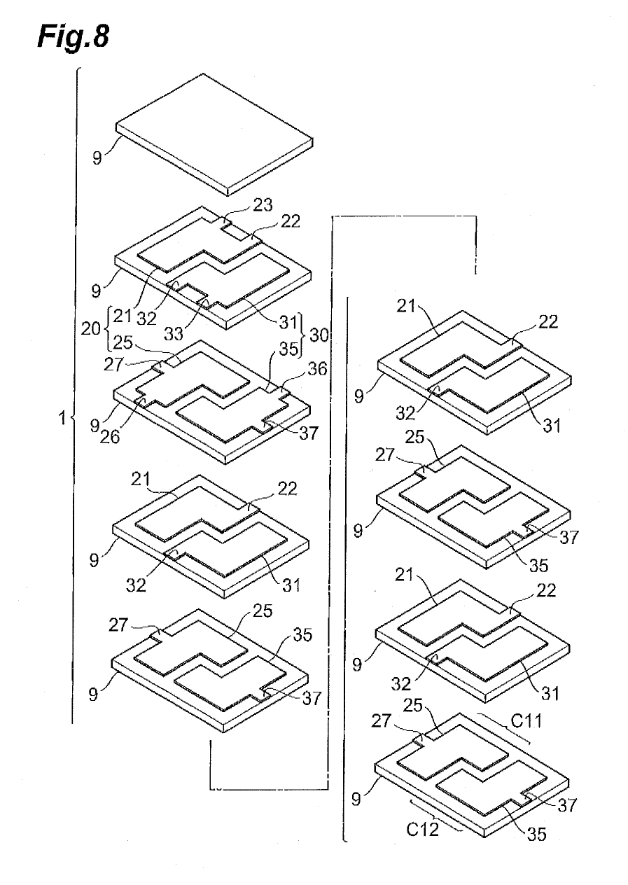

FIG. 8 is an exploded perspective view of the capacitor body (the laminated body 1) included in the multilayer capacitor array C2 shown in FIG. 7. Each second internal electrode 25 has a lead-out conductor 27 extending to the third side surface 6 of the laminated body 1. The lead-out conductor 27 has one end connected to the edge of the second internal electrode 25 close to the third side surface 6 and has the other end exposed to the third side surface 6. The lead-out conductor 27 is integrated with the second internal electrode 25.

The seventh terminal electrode 17 covers all portions of the lead-out conductors 27 which are exposed to the third side surface 6. The lead-out conductors 27 are connected to the seventh terminal electrode 17. Accordingly, the second internal electrodes 25 are electrically connected to each other through the seventh terminal electrode 17. Thus, the second internal electrodes 25 are connected in parallel.

Out of the second internal electrodes 25, the second internal electrode 25 disposed closest to the first main surface 2 has a lead-out conductor 26 in addition to the lead-out conductor 27. Since the second internal electrodes 25 are electrically connected to each other through the seventh terminal electrode 17, all of the second internal electrodes 25 are electrically connected to the second terminal electrode 12.

Each fourth internal electrode 35 has a lead-out conductor 37 extending to the fourth side surface 7 of the laminated body 1. The lead-out conductor 37 has one end connected to the edge of the fourth internal electrode 35 close to the fourth side surface 7 and has the other end exposed to the fourth side surface 7. The lead-out conductor 37 is integrated with the fourth internal electrode 35.

The eighth terminal electrode 18 covers all portions of the lead-out conductors 37 which are exposed to the fourth side surface 7. The lead-out conductors 37 are connected to the eighth terminal electrode 18. Accordingly, the fourth internal electrodes 35 are electrically connected to each other through the eighth terminal electrode 18. Thus, the fourth internal electrodes 35 are connected in parallel.

Out of the fourth internal electrodes 35, the fourth internal electrode 35 disposed closest to the first main surface 2 has a lead-out conductor 36 in addition to the lead-out conductor 37. Since the fourth internal electrodes 35 are electrically connected to each other through the eighth terminal electrode 18, all of the fourth internal electrodes 35 are electrically connected to the fourth terminal electrode 14.

Thus, in the multilayer capacitor array C2, the first and second capacitors C11 and C12 are provided similarly to the multilayer capacitor array C1. The multilayer capacitor array C2 according to this embodiment can be manufactured by the same method for manufacturing the above-described multilayer capacitor array C1.

The preferred embodiments of the present invention are described above, but the present invention is not limited to the embodiments. For example, the present invention is described using the multilayer capacitor array in the above embodiments, but the present invention is not limited thereto. The ceramic electronic component of the present invention may be a common mode filter array or a chip varistor array, for example. Also, the shape of the laminated body 1 and the ceramic electronic component is not limited to a rectangular parallelepiped shape. The laminated body 1 or the ceramic electronic component having a cubic shape or rectangular parallelepiped shape may be chamfered at its corners to have k-shaped ridges.

According to the present invention, an array-type ceramic electronic component having terminal electrodes which have excellent dimensional accuracy and in which a variation in thickness is sufficiently suppressed can be provided.

What is claimed is:

1. An array-type ceramic electronic component comprising:
a ceramic body in which internal electrodes are buried; and
a plurality of terminal electrodes provided on the ceramic body,
wherein each of the terminal electrodes has a first electrode layer formed by baking a conductive green sheet.

2. The ceramic electronic component according to claim 1, further comprising a second electrode layer formed by baking a conductive paste between the first electrode layer and the ceramic body.

3. The ceramic electronic component according to claim 2, wherein the first electrode layer covers the whole second electrode layer on a corner of the ceramic body.

4. The ceramic electronic component according to claim 2, wherein the first electrode layer covers part of the second electrode layer on at least one plane of main surfaces and side surfaces of the ceramic body.

5. The ceramic electronic component according to claim 3, wherein the first electrode layer covers part of the second electrode layer on at least one plane of main surfaces and side surfaces of the ceramic body.
